(19) United States
(12) Patent Application Publication
(10) Pub. No.: US 2009/0238393 A1
(43) Pub. Date: Sep. 24, 2009

(54) Package for array microphones

(75) Inventor: Bo Zhang, Nanjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/050,203

(22) Filed: Mar. 18, 2008

(51) Int. Cl. H04R 11/04

(52) U.S. Cl. 381/361

(57) ABSTRACT

A package for storing microphones includes a main body, a plurality of hollows, and a cover. The hollows are spaced apart and arranged in rows and columns on the main body. Each hollow has a plurality of cavities provided therein to store the microphones. The cover covers the main body and the microphones in the hollows.

### BACKGROUND OF THE INVENTION

1. Field of the Invention

The invention relates to a package for microphones, and more particularly to a package for array microphones.

2. Description of the Related Art

Generally, microphones require packaging for storage and transportation. FIG. 1A depicts conventional package for storing microphones, wherein the package 10 has a box-shaped main body 12, and a plurality of cavities 14 are provided on the main body 12 for storing microphones (not shown). The cavities 14 are arranged in rows and connected by grooves 16 as shown in FIG. 1B. The grooves 16 facilitate microphone removal from the cavities 14.

FIGS. 2A and 2B depict another conventional package for storing microphones, wherein the package 20 has a strip-shaped main body 22. A plurality of cavities 24 are longitudinally provided on the main body 22 for storing microphones 23. The cavities 24 are larger than the microphones 23, thus forming gaps 28 therebetween. The gaps 28 facilitate removal of microphones from the cavities 24.

Differing from individual microphones which may operate alone, array microphones include more than one microphone to cooperate and receive sound. Generally, array microphones are provided in pairs. However, the proper pairing of numerous array microphones are often mixed up, when the array microphones are stored in the described packages 10 or 20. It is therefore understood that the described packages 10 and 20 are less suitable for storage of array microphones than that of individual microphones.

### BRIEF SUMMARY OF THE INVENTION

The invention provides a package suitable for storing array microphones as well as individual microphones. The package in accordance with an exemplary embodiment of the invention includes a main body, a plurality of hollows, and a cover. The hollows are spaced apart and arranged in rows and columns on the main body. Each hollow has a plurality of cavities provided therein to store the microphones. The cover covers the main body and the microphones in the hollows.

In another exemplary embodiment, the hollows extend lengthwise and the cavities are arranged longitudinally in the hollows.

In yet another exemplary embodiment, the package further includes a piece of foam disposed between the main body and the cover.

In another exemplary embodiment, the package further includes a double-sided paster disposed between the main body and the piece of foam.

In yet another exemplary embodiment, a package includes a first main body, a plurality of first hollows, a second main body, a plurality of second hollows, and a cover. The first hollows are spaced apart and arranged in rows and columns on the first main body, wherein each first hollow has a plurality of first cavities provided therein to store the microphones. The second main body is laid over the first main body. The second hollows are spaced apart and arranged in rows and columns on the second main body, wherein each second hollow has a plurality of second cavities provided therein to store the microphones. The cover covers the second main body and the microphones in the second hollows.

In yet another exemplary embodiment, the first and second hollows extend lengthwise and the first and second cavities are arranged longitudinally in the first and second hollows, respectively.

In another exemplary embodiment, the package further includes a piece of foam disposed between the second main body and the cover.

In yet another exemplary embodiment, the package further includes a double-sided paster disposed between the second main body and the piece of foam

In another exemplary embodiment, the package further includes a piece of foam disposed between the first main body and the second main body.

In yet another exemplary embodiment, the package further includes a double-sided paster disposed between the first main body and the piece of foam.

In another exemplary embodiment, a package for storing microphones includes a strip-shaped main body, a plurality of first cavities, and a plurality of second cavities. The first cavities are longitudinally arranged on the main body for storing the microphones and spaced apart by a first distance. The second cavities are longitudinally arranged on the main body for storing the microphones, aligned with the first cavities, and also spaced apart by the first distance, wherein one of the second cavities is adjacent to one of the first cavities, and the first cavity and the adjacent second cavity are spaced apart by a second distance exceeding the first distance.

In yet another exemplary embodiment, a package for storing microphones includes a strip-shaped main body and a plurality of first cavities. The first cavities are laterally arranged on the main body for storing the microphones, wherein the first cavities are substantially identical in size and shape.

In another exemplary embodiment, the package further includes a plurality of second cavities laterally arranged on the main body, adjacent and parallel to the first cavities, wherein the second cavities are substantially identical in size and shape.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a top view of a conventional package for storing microphones;

FIG. 1B depicts IB-IB section of the conventional package of FIG. 1A;

FIG. 2A is a top view of another conventional package for storing microphones;

FIG. 2B depicts IIB-IIB section of the conventional package of FIG. 2A;

FIG. 3 is a perspective exploded diagram of a package in accordance with a first embodiment of the invention;

FIG. 4 is a perspective exploded diagram of a package in accordance with a second embodiment of the invention;

FIG. 5 is a perspective exploded diagram of a package in accordance with a third embodiment of the invention;

FIG. 6 is a perspective exploded diagram of a package in accordance with a fourth embodiment of the invention;

FIG. 7 is a top view of a package in accordance with a fifth embodiment of the invention; and

FIG. 8 is a top view of a package in accordance with a sixth embodiment of the invention.

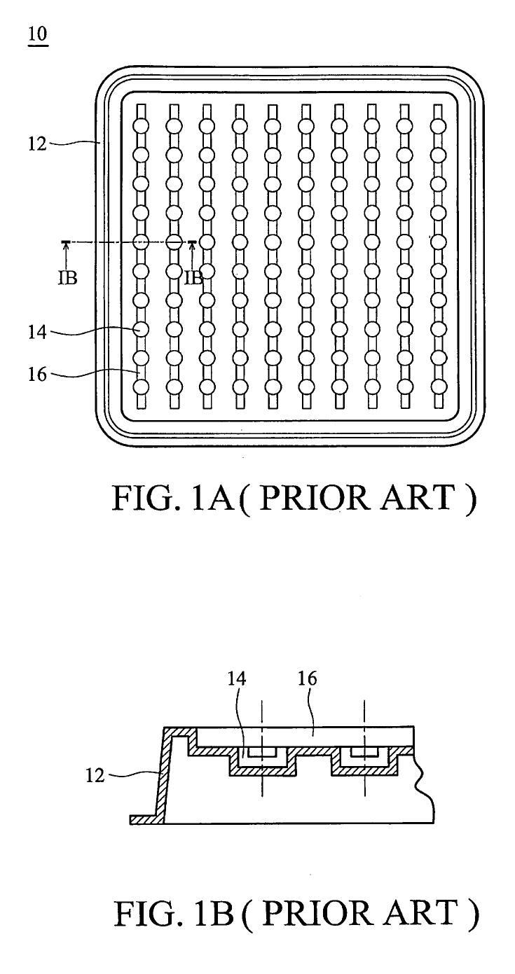

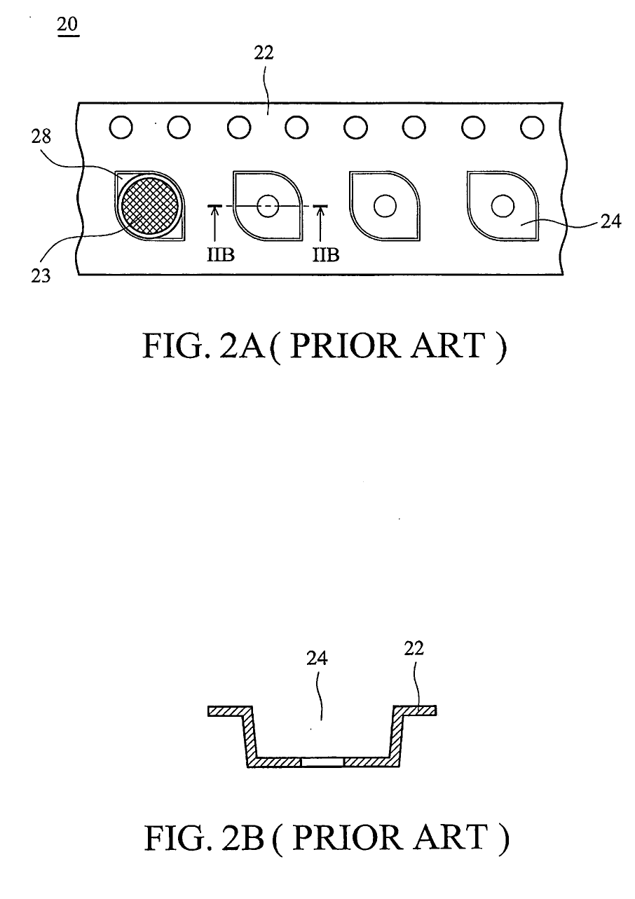

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

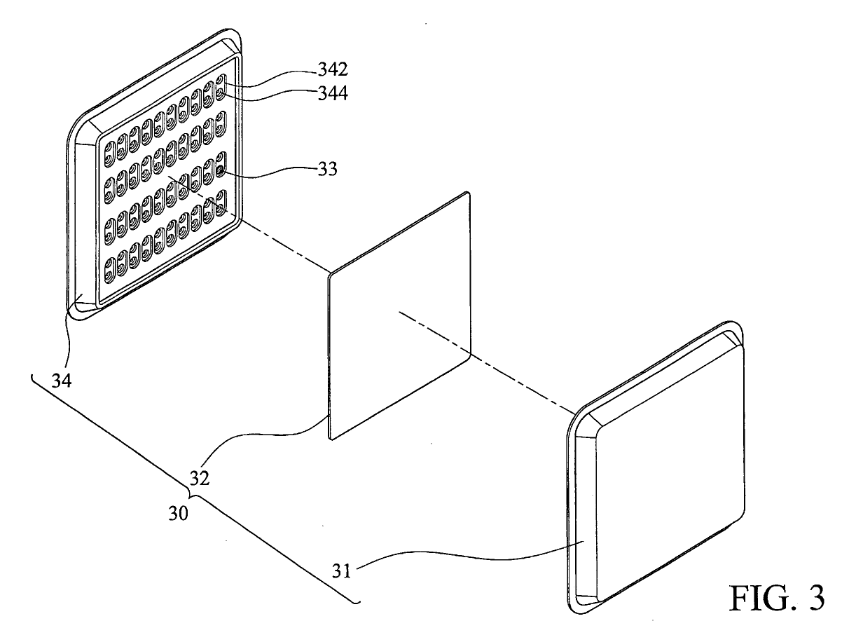

Referring to FIG. 3, a package 30 of a first embodiment of the invention is suitable for storing microphones 33 with pin terminals. The package 30 includes a box-shaped main body 34, a cover 31 covering the main body 34, and a piece of foam 32 disposed between the main body 34 and the cover 31. The main body 34 is rectangular and has a plurality of hollows 342 spaced apart and arranged in rows and columns thereon, wherein each hollow 342 has a plurality of cavities 344 provided therein for storing microphones. Furthermore, each hollow 342 extends lengthwise with the cavities 344 arranged longitudinally therein.

The package 30 is suitable for storing array microphones as well as individual microphones. During storage of array microphones, different pairs of array microphones are located in different hollows 342 which are spaced apart on the main body 34 of the package 30. Thus, it is easy to recognize the pairing of the array microphones.

As described, a piece of foam 32 is disposed between the main body 34 and the cover 31. When the microphones 33 are located in the package 30, the foam 32 allows the pin terminals of the microphones 33 to penetrate inward. Due to the arrangement, the foam 32 is capable of protecting the pin terminals of the microphones 33 from external impact and vibrations during storage and transportation.

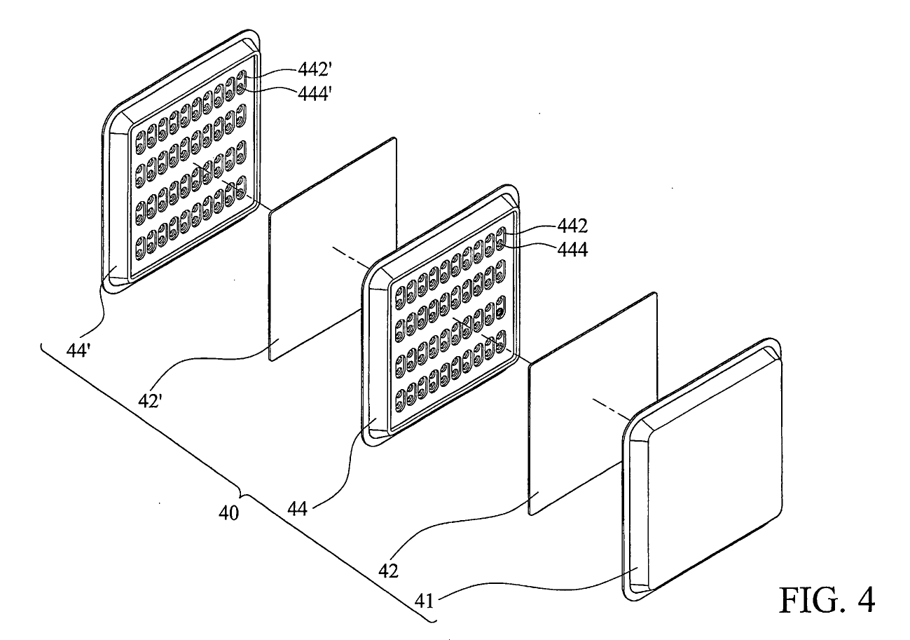

Referring to FIG. 4, a package 40 of a second embodiment of the invention is suitable for storing microphones with pin terminals. The package 40 includes a first main body 44′, a second main body 44 laid over the first main body 44′, a cover 41 covering the second main body 44, and a piece of foam 42′ disposed between the first main body 44′ and the second main body 44, and another piece of foam 42 disposed between the second main body 44 and the cover 41.

The first main body 44′ is box-shaped and has a plurality of hollows 442′ spaced apart and arranged in rows and columns thereon, wherein each hollow 442′ has a plurality of cavities 444′ provided therein for storing microphones. Furthermore, each hollow 442′ extends lengthwise with the cavities 444′ arranged longitudinally therein.

Similarly, the second main body 44 is box-shaped and has a plurality of hollows 442 spaced apart and arranged in rows and columns thereon, wherein each hollow 442 has a plurality of cavities 444 provided therein for storing microphones. Furthermore, each hollow 442 extends lengthwise with the cavities 444 arranged longitudinally therein.

The package 40 is suitable for storing array microphones as well as individual microphones. During storage of array microphones, different groups of array microphones are located in different hollows 442′ and 442 which are spaced apart on the first main body 44′ and the second main body 44 of the package 40, respectively. Thus, it is easy to recognize the pairing of the array microphones.

As described, the foam 42′ and 42 are disposed between the first main body 44′, the second main body 44, and the cover 41. When the microphones are located in the package 40, the foams 42′ and 42 allow the pin terminals of the microphones to penetrate inward. Due to the arrangement, the foams 42′ and 42 are capable of protecting the pin terminals of the microphones from external impact and vibrations during storage and transportation.

From the second embodiment, it is understood that a package of the invention may include more than two box-shaped main bodies to store microphones.

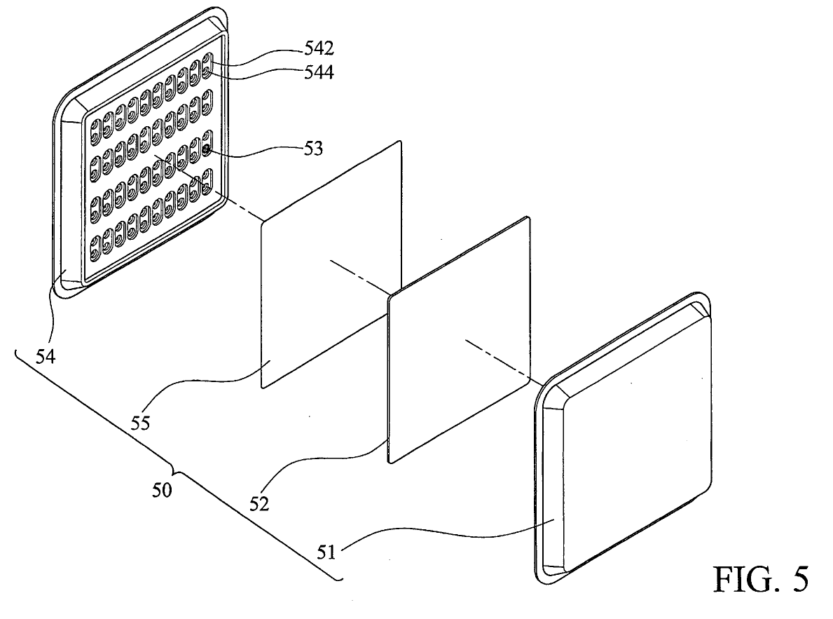

Referring to FIG. 5, a package 50 of a third embodiment of the invention is suitable for storing microphones 53 with lead-wire, FPCB (Flexible Printed Circuit Board), solderless, or surface mount terminals. The package 50 includes a box-shaped main body 54, a cover 51 covering the main body 54, a piece of foam 52 disposed between the main body 54 and the cover 51, and a double-sided paster 55 disposed between the main body 54 and the foam 52. The main body 54 is rectangular and has a plurality of hollows 542 spaced apart and arranged in rows and columns thereon, wherein each hollow 542 has a plurality of cavities 544 provided therein for storing microphones. Furthermore, each hollow 542 extends lengthwise with the cavities 544 arranged longitudinally therein.

The package 50 is suitable for storing array microphones as well as individual microphones. During storage of array microphones, different pairs of array microphones are located in different hollows 542 which are spaced apart on the main body 54 of the package 50. Thus, it is easy to recognize the grouping of the array microphones.

The double-sided paster 55 is attached to the foam 52 with one side thereof. When the microphones 53 are stored in the package 50, the double-sided paster 55 contacts the terminals of the microphones 53 with the other side. Thus, the foam 52 is capable of protecting the microphones 53 from external impact and vibrations during storage and transportation.

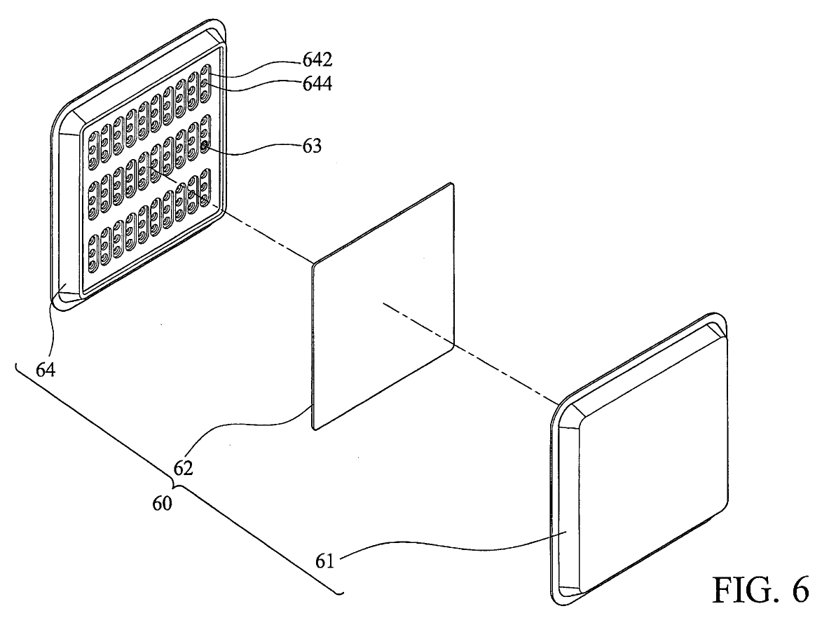

Referring to FIG. 6, a package 60 of a fourth embodiment of the invention is suitable for storing microphones 63 which are provided in triplets. The package 60 includes a box-shaped main body 64, a cover 61 covering the main body 64, and a piece of foam 62 disposed between the main body 64 and the cover 61. The main body 64 is rectangular and has a plurality of hollows 642 spaced apart and arranged in rows and columns thereon, wherein each hollow 642 has three cavities 644 provided therein for storing microphones. Furthermore, each hollow 642 extends lengthwise with the cavities 644 arranged longitudinally therein.

During storage of array microphones, different groups of array microphones are located in different hollows 642 which are spaced apart on the main body 64 of the package 60. Thus, it is easy to recognize the grouping of the array microphones.

As described, a piece of foam 62 is disposed between the main body 64 and the cover 61. When the microphones 63 are located in the package 60, the foam 62 allows the pin terminals of the microphones 63 to penetrate inward. Due to the arrangement, the foam 62 is capable of protecting the pin terminals of the microphones 63 from external impact and vibrations during storage and transportation.

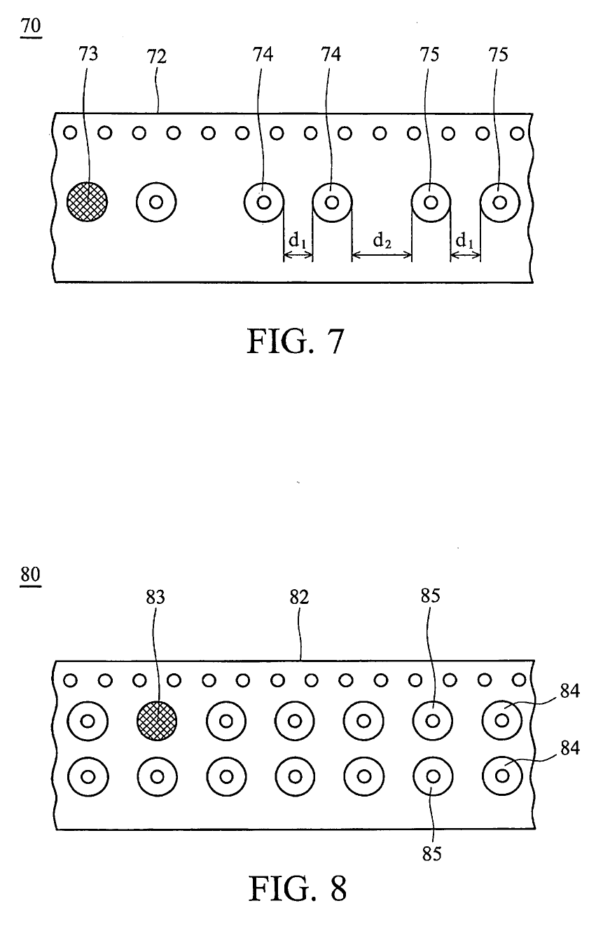

Referring to FIG. 7, a package 70 of a fifth embodiment of the invention has a strip-shaped main body 72. A plurality of cavities is provided longitudinally on the main body 72 for storing the microphones 73. Specifically, a pair of first cavities 74 are longitudinally arranged on the main body 72 and spaced apart by a first distance d₁. A pair of second cavities 75 are longitudinally arranged on the main body 72, aligned with the first cavities 74, and also spaced apart by the first distance d₁, wherein one of the second cavities 75 is adjacent to one of the first cavities 74, and the first cavity 74 and the adjacent second cavity 75 are spaced apart by a second distance d₂ exceeding the first distance d₁ (d₂≧d₁).

The package 70 is suitable for storing array microphones as well as individual microphones. During storage, each pair of array microphones are spaced apart from the adjacent pair by a second distance d₂ exceeding the first distance d₁ between the microphones of the same pair. Thus, it is easy to recognize the pairing of the array microphones.

Referring to FIG. 8, a package 80 of a sixth embodiment of the invention has a strip-shaped main body 82. A plurality of cavities, substantially identical in size and shape, is provided in pairs on the main body 82 for storing the microphones 83. Specifically, a pair of first cavities 84 is laterally arranged on the main body 82. A pair of second cavities 85 is laterally arranged on the main body 82, adjacent and parallel to the first cavities 84.

During storage, different pairs of array microphones are located in different pairs of cavities. Thus, it is easy to recognize the pairing of the array microphones.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A package for storing microphones, comprising:
a main body;
a plurality of hollows spaced apart and arranged in rows and columns on the main body, wherein each hollow has a plurality of cavities provided therein to store the microphones; and
a cover covering the main body and the microphones in the hollows.

2. The package as claimed in claim 1, wherein the hollows extend lengthwise and the cavities are arranged longitudinally in the hollows.

3. The package as claimed in claim 1, further comprising a piece of foam disposed between the main body and the cover.

4. The package as claimed in claim 3, further comprising a double-sided paster disposed between the main body and the piece of foam.

5. A package for storing microphones, comprising:
a first main body;
a plurality of first hollows spaced apart and arranged in rows and columns on the first main body, wherein each first hollow has a plurality of first cavities provided therein to store the microphones;
a second main body laid over the first main body;
a plurality of second hollows spaced apart and arranged in rows and columns on the second main body, wherein each second hollow has a plurality of second cavities provided therein to store the microphones; and
a cover covering the second main body and the microphones in the second hollows.

6. The package as claimed in claim 5, wherein the first and second hollows extend lengthwise and the first and second cavities are arranged longitudinally in the first and second hollows, respectively.

7. The package as claimed in claim 5, further comprising a piece of foam disposed between the second main body and the cover.

8. The package as claimed in claim 7, further comprising a double-sided paster disposed between the second main body and the piece of foam.

9. The package as claimed in claim 5, further comprising a piece of foam disposed between the first main body and the second main body.

10. The package as claimed in claim 9, further comprising a double-sided paster disposed between the first main body and the piece of foam.

11. A package for storing microphones, comprising:
a strip-shaped main body;
a plurality of first cavities longitudinally arranged on the main body for storing the microphones and spaced apart by a first distance; and
a plurality of second cavities longitudinally arranged on the main body for storing the microphones, aligned with the first cavities, and also spaced apart by the first distance, wherein one of the second cavities is adjacent to one of the first cavities, and the first cavity and the adjacent second cavity are spaced apart by a second distance exceeding the first distance.

12. A package for storing microphones, comprising:
a strip-shaped main body; and
a plurality of first cavities laterally arranged on the main body for storing the microphones, wherein the first cavities are substantially identical in size and shape.

13. The package as claimed in claim 12, further comprising a plurality of second cavities laterally arranged on the main body, adjacent and parallel to the first cavities, wherein the second cavities are substantially identical in size and shape.
